(19) United States
(12) Patent Application Publication
(10) Pub. No.: US 2015/0011270 A1
(43) Pub. Date: Jan. 8, 2015

(54) METHOD OF DEPOSITING A METAL LAYER ON AN ELECTRICALLY NON-CONDUCTIVE PLASTIC MEMBER, AND HOUSING FOR A MOBILE DEVICE

(71) Applicant: Amphenol Taiwan Corporation, Taoyuan City (TW)

(72) Inventors: Yung-Sheng TSENG, Taoyuan City (TW); Tzu-Ting HUANG, Taoyuan City (TW); Yi-Tsung LIU, New Taipei City (TW); Chien-Cheng HUA, Taoyuan City (TW); Chih-Hsiang YEH, Taoyuan City (TW)

(21) Appl. No.: 14/322,658

(22) Filed: Jul. 2, 2014

(30) Foreign Application Priority Data
Jul. 4, 2013 (TW) 102123981

(51) Int. Cl. C23C 18/20; C23C 18/28; H04B 1/38; C23C 18/32; C23C 18/38; H04M 1/02; C23C 18/16; C23C 18/30

(52) U.S. Cl. CPC C23C 18/204; C23C 18/1612; C23C 18/1641; C23C 18/285; C23C 18/30; C23C 18/32; C23C 18/38; H04M 1/0202; H04B 1/3888
USPC 455/575.1; 427/553

(57) ABSTRACT

A method of depositing a metal layer on an electrically non-conductive plastic member includes: mixing a plastic material and a laser-sensitive additive to form a mixture, followed by injection molding the mixture to form an electrically non-conductive plastic member; irradiating a part of a surface of the electrically non-conductive plastic member with laser to engrave the electrically non-conductive plastic member so as to form a roughened region; forming an activating layer on the roughened region; and forming a metal layer on the activating layer on the roughened region of the electrically non-conductive plastic member. This method is suitable for making a housing for a mobile device.

### CROSS-REFERENCE TO RELATED APPLICATION

This application claims priority of Taiwanese patent application no, 102123981, filed on Jul. 4, 2013, the entire disclosure of which is hereby incorporated by reference.

### BACKGROUND OF THE INVENTION

1. Field of the Invention

This invention relates to a method of depositing a metal layer on an electrically non-conductive plastic member, and to a housing for a mobile device.

2. Description of the Related Art

Currently, a mobile communication device is designed Toward volume miniaturization. In order no achieve volume miniaturization, an antenna 15 usually formed directly on a back cover of the mobile communication device.

U.S. Pat. No. 7,060,421 B2 discloses a method for producing conductor track structures on an electrically non-conductive support material. An electrically non-conductive metal compounds are insoluble spinel-based inorganic oxides and are dispersed in the support material. The conductor track structures are formed on the supporting material by depositing a metalized layer on metal nuclei produced by using electromagnetic radiation to break up the electrically non-conductive metal compounds.

Another process of forming the antenna on the back cover of the mobile communication device includes the following steps: (1) mixing copper and palladium ions with a plastic material to form a mixture, followed by injection molding the mixture to form a back cover of the mobile communication device; (2) irradiating a part of a surface of the back cover with laser to activate the copper and palladium ions; and (3) depositing a metal layer on the part of the surface of the back cover where the copper and palladium ions are activated so as to form an antenna. It should be noted that palladium ion is used as a bridge to interconnect the back cover and the metal layer.

In the aforesaid method, palladium ion, which is a relatively expensive metal, is spread throughout the whole plastic material of the back cover while the antenna is only formed on a certain part of the back cover. This results in a relatively high incurred cost in this method. Moreover, physical properties (e.g., hardness, brittleness, elasticity, etc.) of the plastic material dispersed with copper and palladium ions are changed, and thus, the quality of the back cover might not be able to meet all requirements in the industry. Furthermore, the abovementioned process is only suitable for certain kinds of plastic materials.

### SUMMARY OF THE INVENTION

Therefore, the object of the present invention is to provide a method of depositing a metal layer on an electrically non-conductive plastic member, and a housing for a mobile device, that can overcome at least one of the aforesaid drawbacks of the prior art.

According to one aspect of this invention, a method of depositing a metal layer on an electrically non-conductive plastic member comprises the following steps:

(a) mixing a plastic material and a laser-sensitive additive to form a mixture, followed by injection molding the mixture to form an electrically non-conductive plastic member that has a surface;

(b) irradiating a part of the surface of the electrically non-conductive plastic member with laser to engrave the electrically non-conductive plastic member so as to form a roughened region in the electrically non-conductive plastic member;

(c) forming an activating layer on the roughened region of the electrically non-conductive plastic member for metalizing the roughened region in the electrically non-conductive plastic member; and

(d) forming a metal layer on the activating layer on the roughened region of the electrically non-conductive plastic member.

According to another aspect of the invention, there is provided a housing for a mobile device, which is made by the abovementioned method of this invention.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a flowchart of the preferred embodiment of a method of depositing a metal layer on an electrically non-conductive plastic member according to this invention;

FIG. 2 is a fragmentary enlarged schematic view showing the electrically non-conductive plastic member formed in the preferred embodiment, which includes a plastic body dispersed with a laser-sensitive additive;

FIG. 3 is a fragmentary enlarged. schematic view showing a step of irradiating the electrically non-conductive plastic member with laser to form a roughened. region in the electrically non-conductive plastic member;

FIG. 4 is a fragmentary enlarged. schematic view showing a step of deposition of a tin-palladium alloy layer on the roughened region of the electrically non-conductive plastic member;

FIG. 5 is a fragmentary enlarged schematic view showing a step of forming an activating layer on the roughened region;

FIG. 6 is a fragmentary enlarged schematic view showing a step of forming a metal layer on the activating layer on the roughened region of the electrically non-conductive plastic member; and

FIG. 7 is a perspective view of a housing for a mobile device made by the preferred embodiment of the method according to this invention.

### DETAILED DESCRIPTION OF THE PREFERRED EMBODIMENT

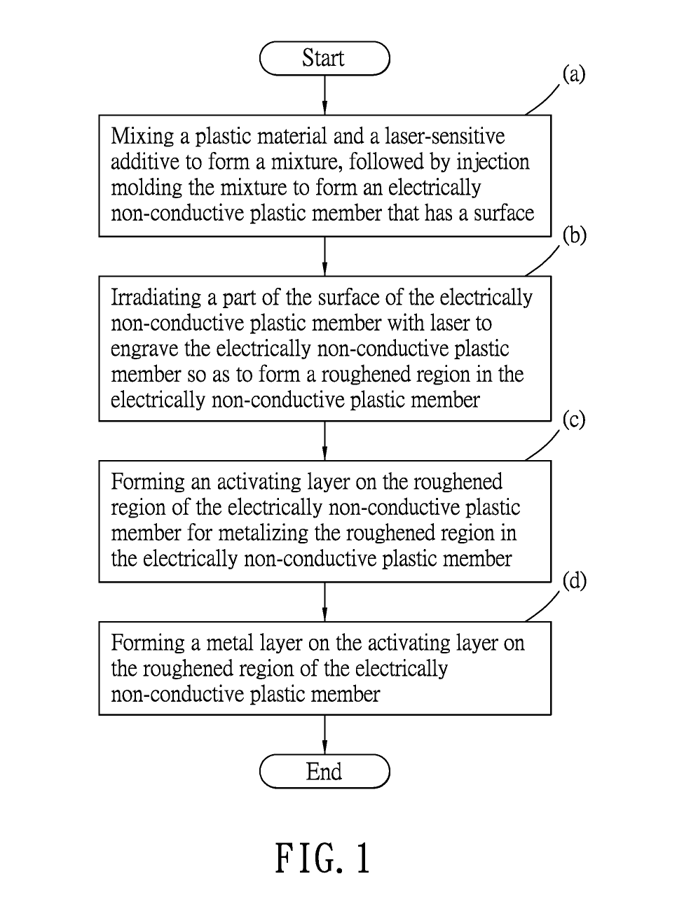

Referring to FIGS. 1 to 6, the preferred embodiment of a method of depositing a metal layer 5 on an electrically non-conductive plastic member 100 according to the present invention is shown to include the following steps:

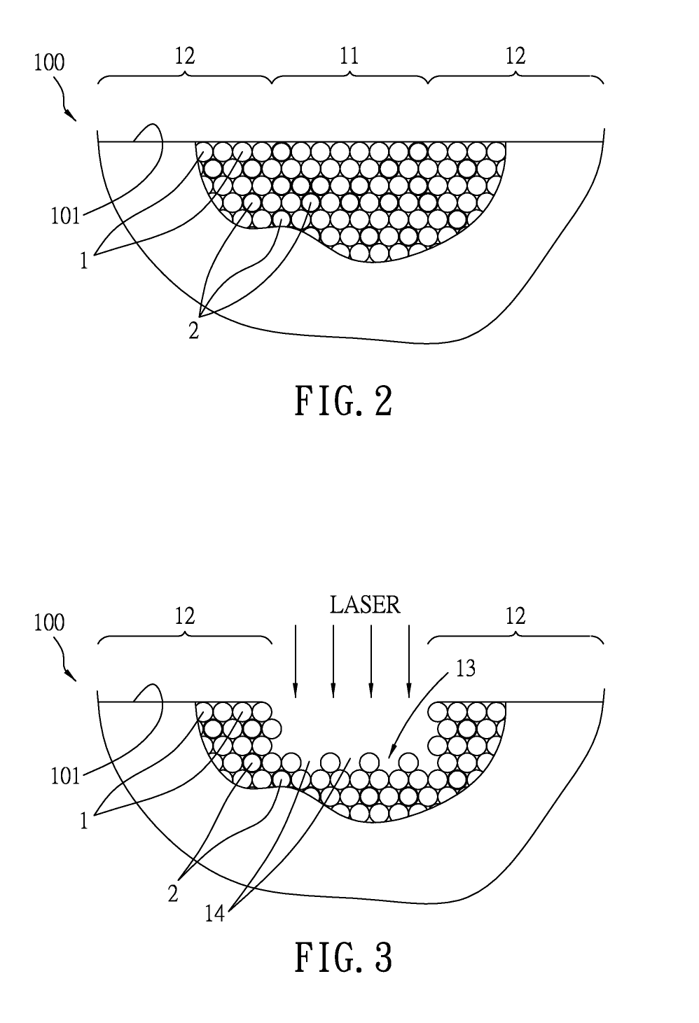

(a) mixing a plastic. ma serial and a laser-sensitive additive 2 to form a mixture, followed by injection molding the mixture to form an electrically non-conductive plastic member 100 that has a surface 101 (see FIG. 2) , the surface 101 being divided into an irradiating area 11 and a non-irradiating area 12;

(b) irradiating the irradiating area 11 of the surface 101 of the electrically non-conductive plastic member 100 with laser to engrave the electrically non-conductive plastic member 100 so as to form a roughened region 13 in the electrically non-conductive plastic member 100 (see FIG. 3);

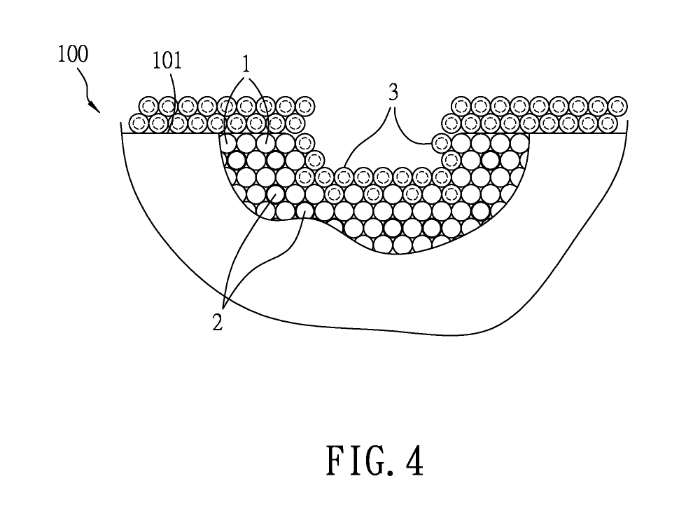

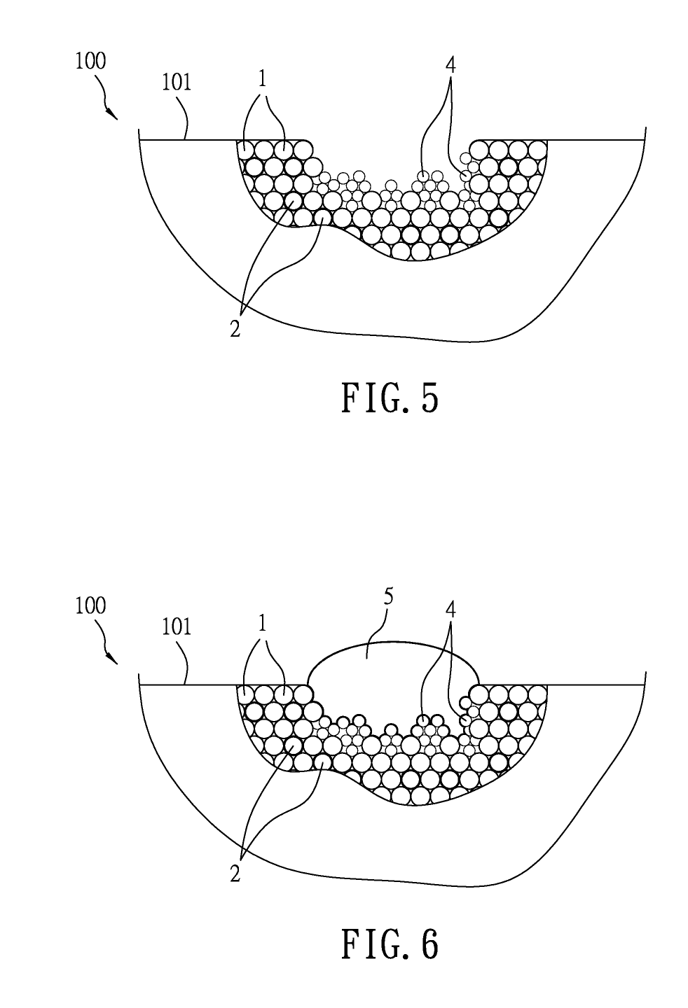

(c) forming an activating layer 4 on the roughened region 13 of the electrically non-conductive plastic member 100 for metalizing the roughened region 13 in the electrically non-conductive plastic member 100 (see FIGS. 4 and 5); and

(d) forming a metal layer 5 on the activating layer on the roughened region 13 of the electrically non-conductive plastic member 100 (see FIG. 6).

Referring to FIGS. 1 and 2, in step (a), the electrically non-conductive plastic member 100 includes a plastic body 1 and the laser-sensitive additive 2 dispersed in the plastic body 1. The plastic material is, for example but not limited to, acrylonitrile butadiene styrene (ABS), polybutylene terephthalate (PBT), or polycarbonate (PC). Preferably, the laser-sensitive additive 2 has a particle size of micro-scale or nano-scale. More preferably, the laser-sensitive additive 2 is a nano-scale laser-sensitive additive that is able to improve quality and accuracy of a pattern of the roughed region 13 formed by laser. The laser-sensitive additive 2 is, for example but not limited to, Lazerflair® (commercially available from MERCK Company in Germany).

Referring to FIGS. 1 and 3, in step (b), as the laser-sensitive additive 2 absorbs the energy of laser light, the temperature of the irradiating area increases to induce carbonization and vaporization of the plastic body 1 of the electrically non-conductive plastic member 100 so as to engrave and roughen the electrically non-conductive plastic member 100, thereby forming the roughened region 13 with a plurality of indentations 14.

The roughened region 13 with the indentations 14 may improve the bonding strength of an alloy layer subsequently formed thereon.

Referring to FIGS. 1, 4 and 5, in step (c), a tin-palladium alloy layer 3 is formed on the roughened region 13 and the non-irradiation area 12 of the electrically non-conductive plastic member 100 by deposition followed by an acid pickling procedure to remove tin ions of the tin-palladium alloy layer 3. After the acid pickling procedure, due to the different roughening degrees, palladium ions only remain on the roughened region 13 but not on the non-irradiating area 12. That is, palladium ions on the non-irradiating area are also removed by acid pickling since the non-irradiating area 12 is not able to provide sufficient bonding strength to the palladium ions as compared to the roughened region 13. Palladium ions that remain on the roughened region 13 thus form the activating layer 4 in step (c).

Alternatively, in step (c), the activating layer 4 can be formed by directly immersing the electrically non-conductive plastic member 100 in an activating liquid containing palladium nano-particle. For example, the activating liquid may contain palladium sulfide or palladium chloride so as to provide palladium nano-particle. The activating liquid is chosen based on the plastic materials used in step (a). Since formation of the palladium activating layer 4 is well known to a skilled artisan, a detailed description thereof is omitted herein for the sake of brevity. A publication with relevant information is “Studying Pd nanoparticles as activator application for electroless copper deposition” (C. C. Tseng, Y. C. Chen, C. P. Chang, J. L. Kuo and M. D. Ger; Journal of C.C.I.T.; Vol. 40; NO. 1; May, 2011).

Referring to FIGS. 1 and 6, in step (d), the metal layer 5 is formed on the activating layer 4 by deposition. Preferably, the metal layer 5 is made of copper or nickel. Palladium are used as a catalyst for reducing metal ions (e.g., copper ions) so that the metal layer 5 can be attached on the activating layer 4. As such, the metal layer 5 can be attached on the electrically non-conductive plastic member 100 via the activating layer 4.

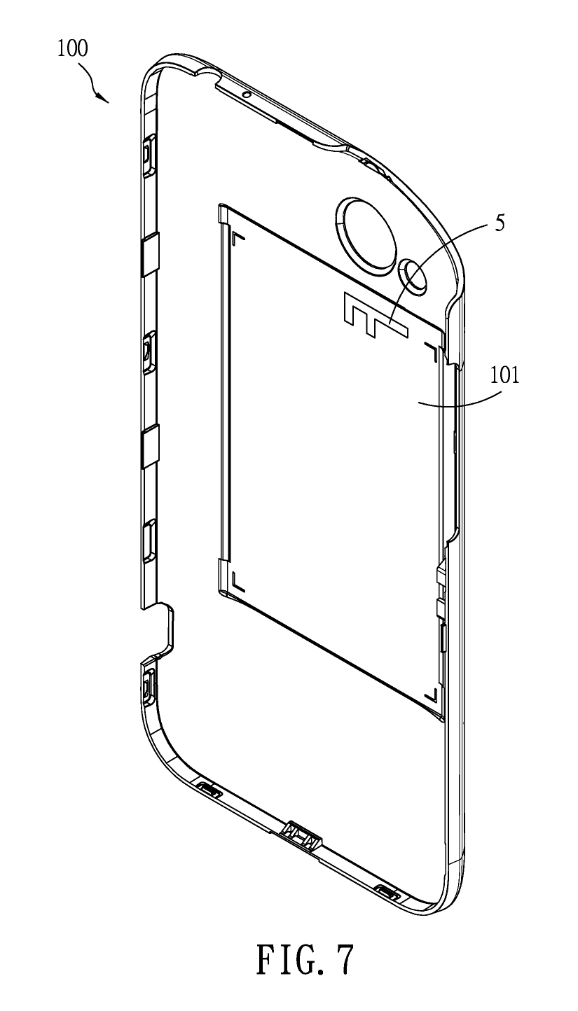

Referring to FIG. 7, the electrically non-conductive plastic member 100 formed with the metal layer 5 may be used as a housing for a mobile device. The metal layer 5 may serve as a radiator of an antenna that is capable of transceiving radio-frequency signals. In this embodiment, the metal layer 5 is formed as, for example but not limited to, an inverted F-shape on an inner surface of the housing of the mobile device. However, in practice, the metal layer 5 can be formed on an outer surface of the housing with various shapes. The metal layer 5 can also be used as a near field communication (NFC) antenna or a monopole antenna.

To sum up, by virtue of the laser-sensitive additive 2, the roughened region 13 of the electrically non-conductive plastic member 100 could be formed and the activating layer 4 may be formed only in the roughened region 13, so that production costs could be effectively reduced. Moreover, since the activating layer 4 is only formed on a part of the surface of the electrically non-conductive plastic member 100, the effect of the activating layer 4 on the physical properties (e.g., hardness, brittleness, and elasticity) of the electrically non-conductive plastic member 100 could be minimized. Furthermore, the method of depositing a metal layer 5 on an electrically non-conductive plastic member 100 according to the present invention is suitable for various kinds of plastic materials.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method of depositing a metal layer on an electrically non-conductive plastic member, comprising the steps of:
(a) mixing a plastic material and a laser-sensitive additive to form a mixture, followed by injection molding the mixture to form an electrically non-conductive plastic member that has a surface;
(b) irradiating a part of the surface of the electrically non-conductive plastic member with laser to engrave the electrically non-conductive plastic member so as to form a roughened region in the electrically non-conductive plastic member;
(a) forming an activating layer on the roughened region of the electrically non-conductive plastic member for metalizing the roughened region in the electrically non-conductive plastic member; and
(d) forming a metal layer on the activating layer on the roughened region of the electrically non-conductive plastic member.

2. The method as claimed in claim 1, wherein in step (c), the activating layer is made of palladium.

3. The method as claimed in claim 2, wherein in step (c), a tin-palladium alloy layer is formed on the roughened region of the electrically non-conductive plastic member by deposition, followed by removing tin ion from the tin-palladium alloy layer by acid pickling so that palladium remains on the roughened region to form the activating layer in step (c).

4. The method as claimed in claim 2, wherein in step (c), the electrically non-conductive plastic member is immersed in an activating liquid containing palladium nano-particle so as to form the activating layer on the roughened region of the electrically non-conductive plastic member.

5. The method as claimed in claim 1, wherein in step (d), the metal layer is made of copper or nickel.

6. The method as claimed in claim 1, wherein in step (d), the metal layer is formed by deposition.

7. The method as claimed in claim 1, wherein in step (d), the metal layer is an antenna capable of transceiving radio frequency signals.

8. A housing for a mobile device, which is made by the method as claimed in claim 1.
